(19) United States
(12) Patent Application Publication
(10) Pub. No.: US 2012/0154945 A1
(43) Pub. Date: Jun. 21, 2012

(54) OPTICAL APERTURES AND APPLICATIONS THEREOF

(76) Inventor: William Mark Hiatt, Charlotte, NC (US)

(21) Appl. No.: 12/970,680

(22) Filed: Dec. 16, 2010

(51) Int. Cl. G02B 7/00

(52) U.S. Cl. 359/894

(57) ABSTRACT

In one aspect, the present invention provides wafer level optical assemblies comprising one or more optical apertures spaced apart from optical wafers and/or optical wafer substrates. In some embodiments, a wafer level assembly described herein comprises a first wafer comprising a first perforation and a first aperture aligned with the first perforation and coupled to the first wafer.

### FIELD OF THE INVENTION

The present invention relates to optical apertures and, in particular, to optical apertures for wafer level optical systems.

### BACKGROUND OF THE INVENTION

Wafer level fabrication techniques provide for the efficient and high volume production of optical elements and other components used in optical imaging apparatus. Several existing wafer level fabrication techniques for optical elements employ a transparent substrate wafer onto which optical structures, such as lenses, are formed. The transparent substrate wafer provides mechanical rigidity to the optical elements, thereby facilitating downstream handling and processing. Moreover, transparent substrate wafers provide surfaces for the installation of one or more apertures for controlling the transmission of the desired amount of electromagnetic radiation to or from other optical components or sensing components of an optical system.

Deposition of one or more apertures on a transparent substrate wafer, however, can have several associated disadvantages, including warping the substrate wafer due to stresses induced by the aperture material. Substrate warping resulting from aperture formation is compounded by optical surface replication where further stresses on the wafer are induced by deposition of the replication material. Substrate wafer warping can complicate wafer handling and degrade lens performance leading to reliability failures and increase optical element production inefficiencies. Furthermore, aperture deposition on transparent substrate wafers often restricts the design of optical elements and assemblies, thereby limiting design solutions for various optical problems.

### SUMMARY

The present invention, in one aspect, provides wafer level optical assemblies comprising one or more apertures spaced apart from optical wafers and/or optical wafer substrates. In some embodiments, spacing one or more apertures apart from optical wafers can alleviate one or more of the foregoing manufacturing disadvantages while significantly increasing design options for optical assemblies.

In some embodiments, the present invention provides a wafer level assembly comprising a first wafer comprising a first perforation and a first aperture aligned with the first perforation and coupled to the first wafer. In some embodiments, the first wafer is non-radiation transmissive. Non-radiation transmissive, as used herein, refers to inability to pass or substantially pass radiation in the visible region of the electromagnetic spectrum. In some embodiments, for example, a non-radiation transmissive wafer is a non-optical wafer. The visible region of the electromagnetic spectrum may include some ultraviolet or some infrared wavelengths as these electromagnetic wavelengths are visible by certain image sensing photodetectors. Thus, the term visible is not intended to be limited to the spectrum visible by humans. In some embodiments, the first wafer further comprises a second perforation and a second aperture aligned with the second perforation and coupled to the first wafer.

A wafer level assembly described herein, in some embodiments, further comprises an optical wafer coupled to the first wafer, the optical wafer comprising a first optical element aligned with the first aperture and spaced apart from the first aperture by the first wafer.

Moreover, in some embodiments, a wafer level assembly described herein, further comprises a second wafer comprising a first perforation aligned with the first aperture of the first wafer, the second wafer coupled to the first aperture. In some embodiments, the second wafer comprises a non-radiation transmissive material. In some embodiments, the second wafer comprises a second perforation, wherein the second perforation is aligned with the second aperture of the first wafer.

In some embodiments of a wafer level assembly comprising first and second wafers as described herein, an optical wafer is coupled to the first wafer, the optical wafer comprising a first optical element aligned with the first aperture coupled to the first wafer, wherein the optical wafer is spaced apart from the first aperture by the first wafer. In some embodiments, the optical wafer further comprises a second optical element aligned with the second aperture coupled to the first wafer, wherein the optical wafer is spaced apart from the second aperture by the first wafer. Moreover, in some embodiments, an electro-optical element wafer is coupled to the second wafer of the assembly such that the first aperture is disposed between the first optical element and electro-optical element wafer. In some embodiments, the second aperture is disposed between the second optical element and the electro-optical element wafer. In some embodiments, the electro-optical element wafer comprises a first electro-optical element aligned with the first aperture and a second electro-optical element aligned with he second aperture of the assembly.

Alternatively, in some embodiments of a wafer level assembly comprising first and second wafers as described herein, an optical wafer is coupled to the second wafer, the optical wafer comprising a first optical element aligned with the first aperture coupled to the first wafer, wherein the optical wafer is spaced apart from the first aperture by the second wafer. In some embodiments, the optical wafer further comprises a second optical element aligned with the second aperture coupled to the first wafer, wherein the optical wafer is spaced apart from the second aperture by the second wafer. Additionally, in some embodiments, an electro-optical element wafer is coupled to the wafer level assembly such that the first optical element is disposed between the first aperture and the electro-optical element wafer. In some embodiments, the second optical element is disposed between the second aperture and the electro-optical element wafer. In some embodiments wherein the first optical element is disposed between the first aperture and the electro-optical element wafer, a third wafer comprising a first perforation aligned with the first aperture couples the optical wafer to the electro-optical element wafer. In some embodiments, the electro-optical element wafer comprises a first electro-optical element aligned with the first aperture and/or a second electro-optical element aligned with the second aperture.

In another aspect, the present invention provides a wafer level optical assembly comprising an optical wafer comprising a first optical element and a first aperture aligned with the first optical element and coupled to a surface of the optical wafer, the first aperture comprising electroless nickel. In some embodiments, the optical wafer further comprises a second optical element and a second aperture aligned with the second optical element and coupled to a surface of the optical wafer, the second aperture comprising electroless nickel.

In some embodiments, the wafer level assembly further comprises a spacer wafer comprising a first perforation coupled to the optical wafer, the first perforation aligned with the first optical element. In some embodiments, the spacer wafer further comprises a second perforation aligned with the second optical element of the optical wafer. Moreover, in some embodiments, an electro-optical element wafer is coupled to the spacer wafer, the electro-optical element wafer comprising a first electro-optical element aligned with the first optical element. In some embodiments, the electro-optical element wafer further comprises a second electro-optical element aligned with the second optical element.

In another aspect, the present invention provides methods of providing optical apertures. In some embodiments, a method of providing at least one optical aperture comprises providing a substrate comprising a coating, selectively removing portions of the coating from the substrate, depositing an aperture material on substrate surfaces where the coating has been removed or substantially removed, coupling a wafer to the deposited aperture material, and removing the aperture material from the substrate to provide the at least one optical aperture. In some embodiments, a plurality of optical apertures are provided.

In some embodiments of methods described herein a substrate coating comprises an oxide. In some embodiments, a substrate coating comprises a resist material. Moreover, in some embodiments, an aperture material comprises a metal. In one embodiment, for example, an aperture material comprises electrolessly deposited nickel. In some embodiments, an aperture material comprises a polymeric material.

In some embodiments, a method of providing at least one optical aperture comprises providing a substrate, patterning an aperture material on the substrate, coupling a wafer to the patterned aperture material, and removing the aperture material from the substrate to provide the at least one optical aperture. In some embodiments, patterning an aperture material on the substrate comprises depositing the aperture material on the substrate and selectively removing portions of the aperture material to provide a pattern of the aperture material.

In some embodiments, a wafer coupled to the deposited aperture material on a substrate, according to methods described herein, comprises a perforation aligned with the at least one optical aperture. In some embodiments wherein a plurality of optical apertures are produced, a wafer coupled to the deposited aperture material comprises a plurality of perforations aligned with the plurality of apertures. In some embodiments, a wafer coupled to the deposited aperture material is non-radiation transmissive. In some embodiments, a wafer coupled to the deposited aperture material is a spacer wafer.

In some embodiments, a wafer coupled to the deposited aperture material is an optical wafer. In some embodiments, an optical wafer coupled to the deposited aperture material comprises an optical element aligned with the at least one optical aperture. In some embodiments wherein a plurality of optical apertures are produced, the optical wafer coupled to the deposited aperture material comprises a plurality of optical elements aligned with the plurality of apertures. In some embodiments wherein an optical wafer is coupled to the deposited aperture material, the substrate comprises one or more recesses operable to accommodate optical elements aligned with the formed apertures.

These and other embodiments are described in further detail in the detailed description which follows.

### BRIEF DESCRIPTION OF THE DRAWINGS

FIG. 1 illustrates a wafer level assembly according to one embodiment of the present invention.

FIG. 2 illustrates a wafer level assembly according to one embodiment of the present invention.

FIG. 3 illustrates a wafer level assembly according to one embodiment of the present invention.

FIG. 4 illustrates a wafer level assembly according to one embodiment of the present invention.

FIG. 5 illustrates a wafer level assembly according to one embodiment of the present invention.

FIG. 6 illustrates a wafer level assembly according to one embodiment of the present invention.

FIG. 7 illustrates an oxide coated substrate according to one embodiment of the present invention.

FIG. 8 illustrates a substrate having an oxide coating selectively removed according to one embodiment of the present invention.

FIG. 9 illustrates the selective deposition of an aperture material on substrate surfaces according to one embodiment of the present invention.

FIG. 10 illustrates coupling a spacer wafer to a deposited aperture material according to one embodiment of the present invention.

FIG. 11 illustrates removal of an aperture from a substrate according to one embodiment of the present invention.

FIG. 12 illustrates an oxide coated substrate according to one embodiment of the present invention.

FIG. 13 illustrates a substrate having an oxide coating selectively removed according to one embodiment of the present invention.

FIG. 14 illustrates the selective deposition of an aperture material on substrate surfaces according to one embodiment of the present invention.

FIG. 15 illustrates coupling an optical wafer to a deposited aperture material according to one embodiment of the present invention.

FIG. 16 illustrates removal of an aperture from a substrate according to one embodiment of the present invention.

FIG. 17 illustrates a wafer level assembly comprising an electro-optical element which generates electro-magnetic radiation according to one embodiment of the present invention.

### DETAILED DESCRIPTION

The present invention can be understood more readily by reference to the following detailed description, examples and drawings and their previous and following descriptions. Elements, apparatus and methods of the present invention, however, are not limited to the specific embodiments presented in the detailed description, examples and drawings. It should be recognized that these embodiments are merely illustrative of the principles of the present invention. Numerous modifications and adaptations will be readily apparent to those of skill in the art without departing from the spirit and scope of the invention.

In some embodiments, the present invention provides a wafer level assembly comprising a first wafer comprising a first perforation and a first aperture aligned with the first perforation and coupled to the first wafer. In some embodiments, the first wafer is non-radiation transmissive. In some embodiments, the first wafer further comprises a second perforation and a second aperture aligned with the second perforation and coupled to the first wafer.

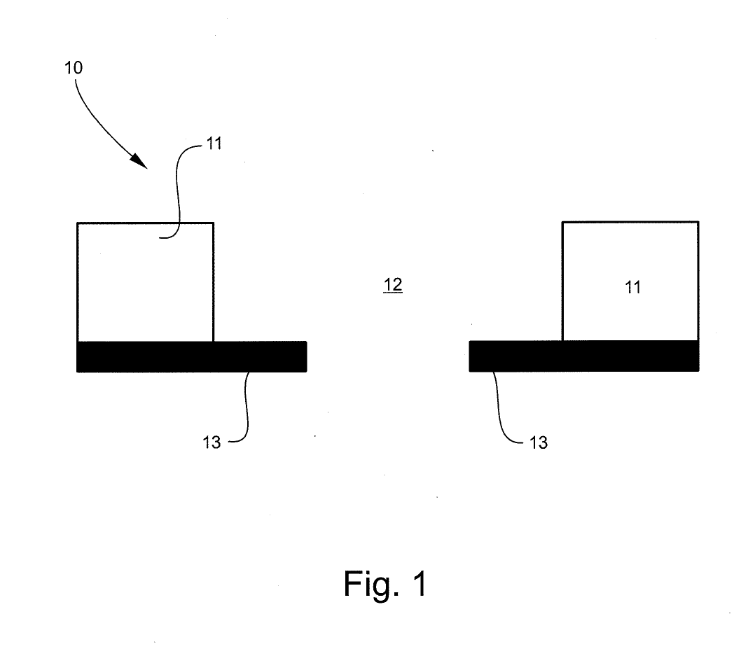

FIG. 1 illustrates a wafer level assembly according to one embodiment of the present invention. The wafer level assembly (10) illustrated in FIG. 1 comprises a non-radiation transmissive wafer (11) comprising a perforation (12). An aperture (13) is coupled to the wafer (11) and aligned with the perforation (12).

A non-radiation transmissive wafer of the various wafer level assemblies described herein, in some embodiments, is a non-optical wafer. In some embodiments, a non-radiation transmissive wafer is a spacer wafer.

A non-radiation transmissive wafer can comprise any material not inconsistent with the objectives of the present invention. In some embodiments, a non-radiation transmissive wafer comprises a polymeric material. In some embodiments, a non-radiation transmissive wafer comprises a fiber-reinforced polymeric material, including glass fiber reinforced polymeric materials. A suitable glass fiber reinforced polymeric material, in some embodiments, comprises a glass fiber reinforced epoxy resin. In one embodiment, for example, a glass fiber reinforced epoxy resin comprises FR-4. Moreover, in some embodiments, a non-radiation transmissive wafer can comprise one or more inorganic materials. Inorganic materials, in some embodiments, comprise metals, metal alloys, metal oxides, ceramics or silicon.

An aperture of the various wafer level assemblies described herein can comprise any material not inconsistent with the objectives of the present'invention. In some embodiments, an aperture comprises a metal or alloy. In some embodiments, a metal comprises aluminum, nickel, copper, zinc, silver or gold or alloys thereof. In some embodiments, for example, an aperture comprises electrolessly deposited nickel. In some embodiments, an electrolessly deposited nickel comprises a nickel-phosphorus alloy. A nickel-phosphorus alloy, in some embodiments, comprises phosphorus in an amount ranging from 0.5 weight percent to about 14 weight percent. In some embodiments, an electrolessly deposited nickel comprises low phosphorus electroless nickel, medium phosphorus electroless nickel or high phosphorus electroless nickel. In some embodiment, an electrolessly deposited nickel comprises a nickel-boron alloy. A nickel-boron alloy, in some embodiments, comprises boron in an amount ranging from about 0.5 weight percent to about 5 weight percent.

In some embodiments, an aperture comprises a polymeric material. A polymeric material of an aperture, in some embodiments, comprises one or more polyolefins, polyamides, polyurethanes, polyesters, epoxides or fluoropolymers. In some embodiments, a polyolefin comprises polyethylene, polypropylene, polybutene or mixtures or copolymers thereof. In some embodiments, a fluoropolymer comprises polytetrafluoroethylene (PTFE), polyvinylfluoride (PVF), polyvinylidene fluoride (PVDF) or mixtures or copolymers thereof.

In some embodiments, an aperture material comprises a lithographic resist. A lithographic resist, in some embodiments, comprises any of the same described herein.

An aperture of wafer level assemblies described herein can have any dimensions not inconsistent with the objectives of the present invention. In some embodiments, an aperture has a thickness sufficient to be non-radiation transmissive. In some embodiments, an aperture has a thickness ranging from about 100 nm to about 200 μm. In some embodiments, an aperture has a thickness ranging from about 200 nm to about 10 μm or from about 500 nm to about 1 μm.

In some embodiments, a wafer level assembly described herein further comprises a second wafer comprising a first perforation aligned with the first aperture of the first wafer, wherein the second wafer is coupled to the first aperture. In some embodiments, the second wafer comprises a non-radiation transmissive material as described herein. The second wafer, in some embodiments, further comprises a second perforation, the second perforation aligned with the second aperture of the first wafer.

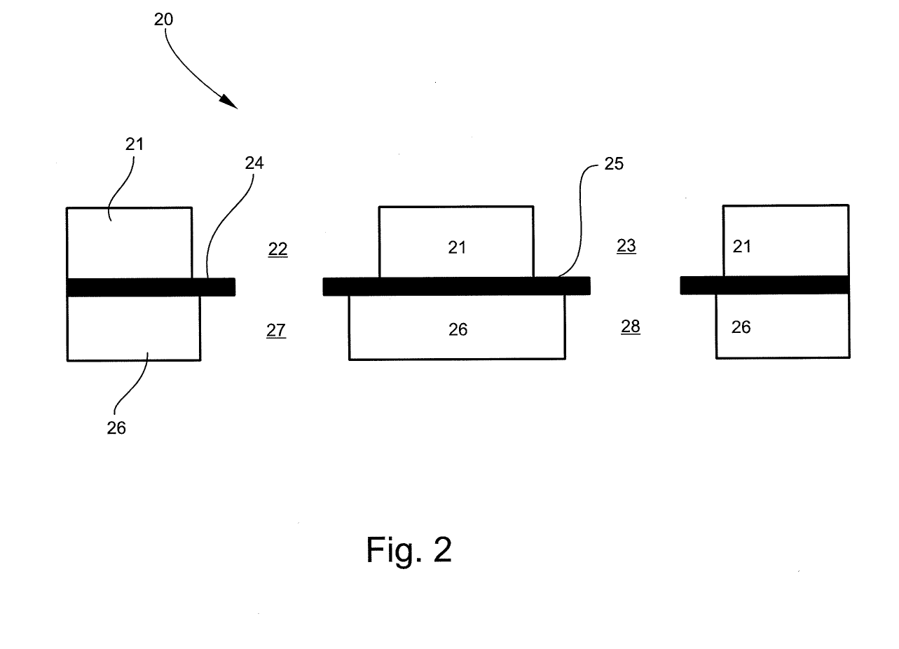

FIG. 2 illustrates a wafer level assembly comprising first and second wafers according to one embodiment of the present invention. As illustrated in FIG. 2, the wafer level assembly (20) comprises a first spacer wafer (21) comprising a first perforation (22) and a second perforation (23). A first aperture (24) is aligned with the first perforation (22) and a second aperture (25) is aligned with the second perforation (23). A second spacer wafer (26) is coupled to the first aperture (24) and the second aperture (25). The second spacer wafer (26) comprises a first perforation (27) aligned with the first aperture (24) and a second perforation (28) aligned with the second aperture (25).

In some embodiments of a wafer level assembly comprising first and second wafers as described herein, an optical wafer is coupled to the first wafer, the optical wafer comprising a first optical element aligned with the first aperture coupled to the first wafer, wherein the optical wafer is spaced apart from the first aperture by the first wafer. In some embodiments, the optical wafer further comprises a second optical element aligned with the second aperture coupled to the first wafer, wherein the optical wafer is spaced apart from the second aperture by the first wafer. Moreover, in some embodiments, an electro-optical element wafer is coupled to the second wafer of the assembly such that the first aperture is disposed between the first optical element and electro-optical element wafer. In some embodiments, the second aperture is disposed between the second optical element and the electro-optical element wafer. In some embodiments, the electro-optical element wafer comprises a first electro-optical element aligned with the first aperture and a second electro-optical element aligned with he second aperture of the assembly.

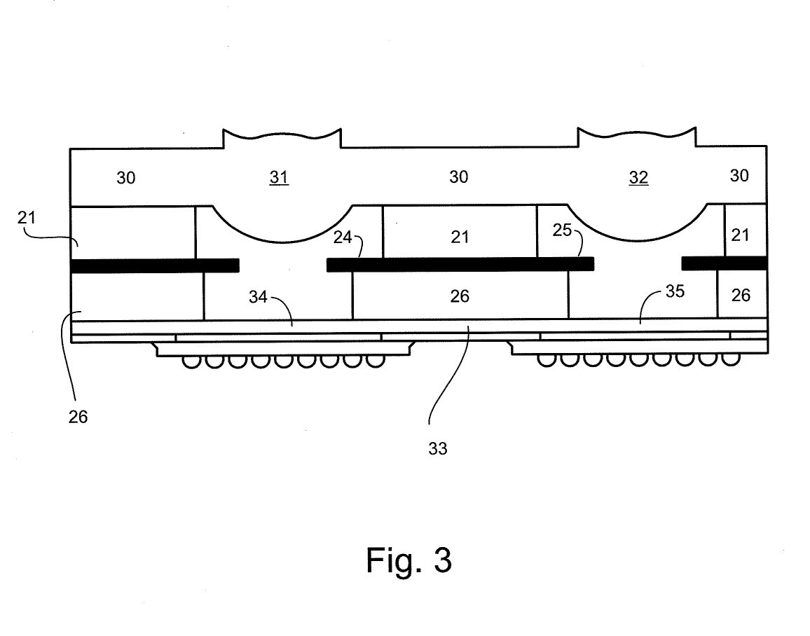

FIG. 3 illustrates the wafer level assembly of FIG. 2 further comprising an optical wafer and an electro-optical element wafer. As illustrated in FIG. 3, an optical wafer (30) is coupled to the first spacer wafer (21). The optical wafer (30) comprises a first optical element (31) aligned with the first aperture (24) and a second optical element (32) aligned with the second aperture (25). The optical wafer (30) and first optical element (31) are spaced apart from the first aperture (24) by the first spacer wafer (21), and the optical wafer (30) and second optical element (32) are spaced apart from the second aperture (25) by the first spacer wafer (21).

An electro-optical element wafer (33) is coupled to the second wafer (26) of the wafer level assembly such that the first aperture (24) is positioned between the first optical element (31) and the electro-optical element wafer (33). Additionally, the second aperture (25) is positioned between the second optical element (32) and the electro-optical element wafer (33). A first electro-optical element (34) of the electro-optical element wafer (33) is aligned with the first aperture (24), and a second electro-optical element (35) is aligned with the second aperture (25). In some embodiments, the optical wafer (30), first and second spacer wafers (21, 26) and electro-optical element wafer (33) are singulated to provide individual wafer level assemblies having the foregoing components.

In some embodiments, one or more apertures of a wafer level assembly are coupled to a non-radiation transmissive wafer such that the aperture material does not reside in one or more dicing lanes of the wafer level assembly. Preclusion of aperture material in dicing lanes of the wafer level assembly, in some embodiments, can assist in singulation processes to provide individual wafer level assemblies described herein and reduce wear on dicing blades and apparatus.

Alternatively, in some embodiments of a wafer level assembly comprising first and second wafers as described herein, an optical wafer is coupled to the second wafer, the optical wafer comprising a first optical element aligned with the first aperture coupled to the first wafer, wherein the optical wafer is spaced apart from the first aperture by the second wafer. In some embodiments, the optical wafer further comprises a second optical element aligned with the second aperture coupled to the first wafer, wherein the optical wafer is spaced apart from the second aperture by the second wafer. Additionally, in some embodiments, an electro-optical element wafer is coupled to the wafer level assembly such that the first optical element is disposed between the first aperture and the electro-optical element wafer. In some embodiments, the second optical element is disposed between the second aperture and the electro-optical element wafer. In some embodiments wherein the first optical element is disposed between the first aperture and the electro-optical element wafer, a third wafer comprising a first perforation aligned with the first aperture couples the optical wafer to the electro-optical element wafer. In some embodiments, the electro-optical element wafer comprises a first electro-optical element aligned with the first aperture and/or a second electro-optical element aligned with the second aperture.

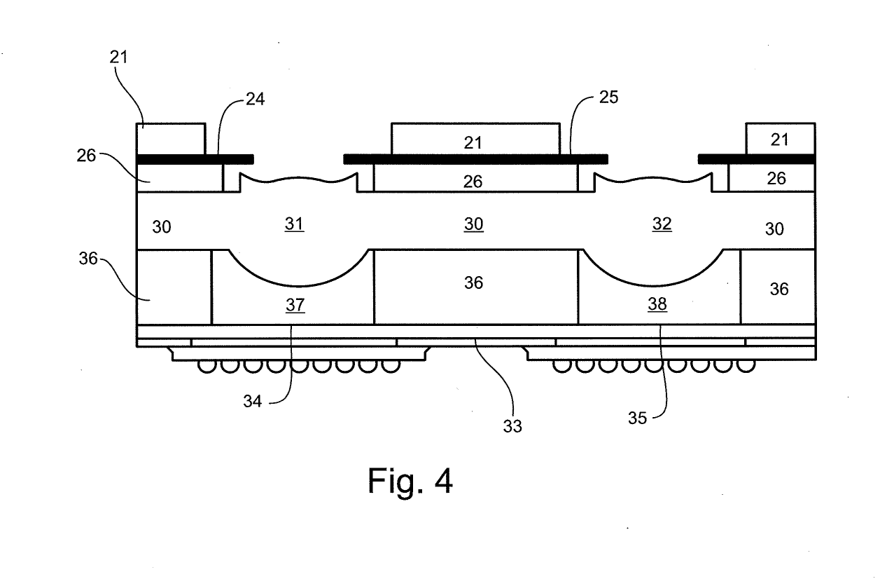

FIG. 4 illustrates the wafer level assembly of FIG. 2 further comprising an optical wafer and an electro-optical element wafer according to another embodiment of the present invention. In the embodiment illustrated in FIG. 4, an optical wafer (30) is coupled to the second spacer wafer (26). The optical wafer comprises a first optical element (31) aligned with the first aperture (24) and a second optical element (32) aligned with the second aperture (25). The first optical element (31) is spaced apart from the first aperture (24) by the second spacer wafer (26), and the second electro-optical element (32) is spaced-apart from the second aperture (25) by the second spacer wafer (26).

A third spacer wafer (36) is additionally coupled to the optical wafer (30), the third spacer wafer (36) comprising a first perforation (37) aligned with the first aperture (25) and a second perforation (38) aligned with the second aperture (26). An electro-optical element wafer (33) is coupled to the third spacer wafer (36) such that the first optical element (31) is positioned between the first aperture (24) and the electro-optical element wafer (33), and the second optical element (32) is positioned between the second aperture (25) and the electro-optical element wafer (33). A first electro-optical element (34) of the electro-optical element wafer (33) is aligned with the first aperture (24), and a second electro-optical element (35) is aligned with the second aperture (25). In some embodiments, the optical wafer (30), first, second and third spacer wafers (21, 26, 36) and electro-optical element wafer (33) are singulated to provide individual wafer level assemblies having the foregoing components.

In some embodiments, an optical wafer for use in the various wafer level assemblies described herein comprises a radiation transmissive substrate comprising at least one optical surface. In some embodiments, a radiation transmissive substrate comprises a plurality of optical surfaces. In some embodiments, a radiation transmissive substrate comprises any suitable type of glass not inconsistent with the objectives of the present invention. In some embodiments, a radiation transmissive substrate comprises any polymeric or sol-gel material not inconsistent with the objectives of the present invention. In some embodiments, radiation transmissive polymeric materials include polycarbonates, polystyrene or polyacrylates such as polyacrylic acid, polymethacrylate, polymethylmethacrylate or mixtures or copolymers thereof.

Moreover, in some embodiments, an optical surface of a radiation transmissive substrate comprises a lens or other refractive optical element operable to interact with electromagnetic radiation.

In some embodiments, for example, an optical surface comprises a convex, concave, spherical, or aspherical shape, including surfaces that are simultaneously concave in some regions and convex in others. In some embodiments, wherein opposing sides of the radiation transmissive substrate comprise optical surfaces, the opposing sides in combination form a biconvex, biconcave, plano-convex, plano-concave, positive meniscus or negative meniscus lens.

In some embodiments, an optical surface comprises a filter material operable to selectively pass or selectively block regions of the electromagnetic spectrum.

In some embodiments, optical surfaces on the radiation transmissive substrate comprise any of the glass or radiation transmissive polymeric materials described herein. In some embodiments, for example, an optical surface comprises one or more epoxides, oxetanes, acrylates, methacrylates, maleate esters, thiol-enes, vinyl ethers or mixtures or copolymers thereof. In some embodiments, an optical surface comprises one or more fluoropolymers, including perfluorocyclobutyl (PFCB) based polymers.

Moreover, in some embodiments, optical surfaces are formed directly on the radiation transmissive substrate. In some embodiments, optical surfaces are formed independent of the radiation transmissive substrate and subsequently coupled or deposited on the radiation transmissive substrate.

Alternatively, in some embodiments, an optical wafer comprising one or more optical surfaces does not comprise a radiation transmissive substrate and is a monolithic molded optical wafer. In some embodiments, a molded optical wafer can comprise any of the radiation transmissive materials described herein.

Wafer level assemblies described herein, in some embodiments, further comprise an electro-optical element wafer comprising at least one electro-optical element. In some embodiments, an electro-optical element wafer comprises a plurality of electro-optical elements.

In some embodiments, an electro-optical element comprises an electromagnetic radiation sensing element. An electromagnetic radiation sensing element, in some embodiments, comprises a photosensitive region operable to detect received electromagnetic radiation.

In some embodiments, the sensing element, including the photosensitive region, comprises a semiconductor. Any suitable semiconductor not inconsistent with the objectives of the present invention can be used for the sensing element, including the photosensitive region. In some embodiments, a semiconductor comprises a Group IV semiconductor, including silicon or any combination of Group IV elements. In another embodiment, a semiconductor comprises a Group III/V semiconductor or a Group II/VI semiconductor.

In some embodiments, the photosensitive region of a sensing element comprises a focal plane array. A focal plane array, in some embodiments, is a VGA sensor, comprising 640×480 pixels. In some embodiments, the sensor includes fewer pixels (e.g., CIF, QCIF), or more pixels (1 or more megapixel).

In one embodiment, a sensing element including the photosensitive region comprises a charge coupled device (CCD). In another embodiment, a sensing element including the photosensitive region comprises a complimentary metal oxide semiconductor (CMOS) architecture.

In some embodiments, an electro-optical element generates electromagnetic radiation. Any desired element for generating electro-magnetic radiation not inconsistent with the objectives of the present invention can be used. In some embodiments an electro-optical element providing electromagnetic radiation comprises one or more light emitting diodes (LED), laser emitters (visible or infrared) such as a vertical cavity surface emitting laser (VCSEL), or combinations thereof. In some embodiments, a LED comprises inorganic materials such as inorganic semiconductors. In other embodiments, a LED comprises organic materials such as organic semiconductors including polymeric semiconductors. In a further embodiment, a LED comprises a mixture of organic and inorganic materials.

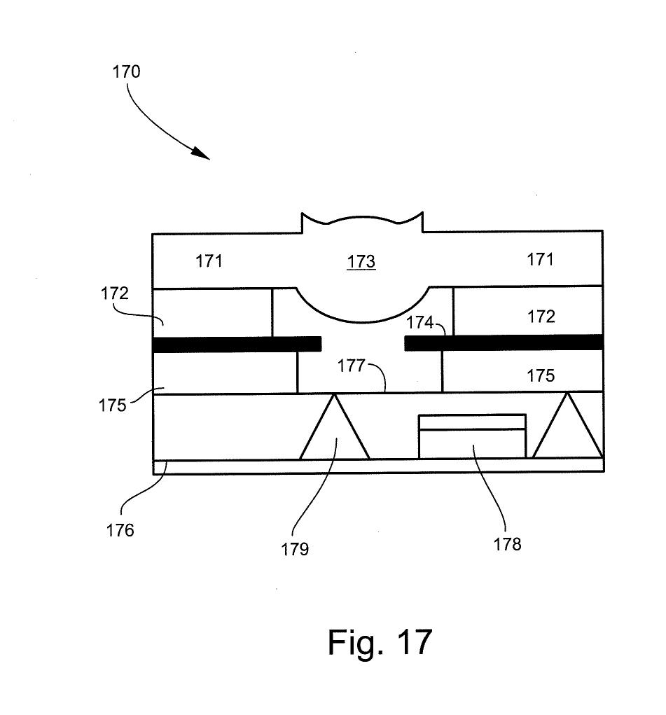

FIG. 17 illustrates a wafer level assembly comprising an electro-optical element which generates electro-magnetic radiation according to one embodiment of the present invention. As illustrated in FIG. 17, the wafer level assembly (170) comprises an optical wafer (171) coupled to a first spacer wafer (172). The optical wafer (171) comprises a first optical element (173) aligned with a first aperture (174). The optical wafer (171) and the first optical element (173) are spaced apart from the first aperture (174) by the first spacer wafer (172).

An electro-optical element wafer (176) is coupled to a second spacer wafer (175) such that the first aperture (174) is positioned between the first optical element (173) and the electro-optical element wafer (176). A first electro-optical element (177) of the electro-optical element wafer (176) is aligned with the first aperture (174). The electro-optical element (177) in the embodiment of FIG. 17 comprises a laser (178) in conjunction with a reflective cavity (179) to provide electromagnetic radiation from the wafer level assembly (170).

In another aspect, the present invention provides a wafer level optical assembly comprising an optical wafer comprising a first optical element and a first aperture aligned with the first optical element and coupled to a surface of the optical wafer, the first aperture comprising electroless nickel. In some embodiments, the optical wafer further comprises a second optical element and a second aperture aligned with the second optical element and coupled to a surface of the optical wafer, the second aperture comprising electroless nickel.

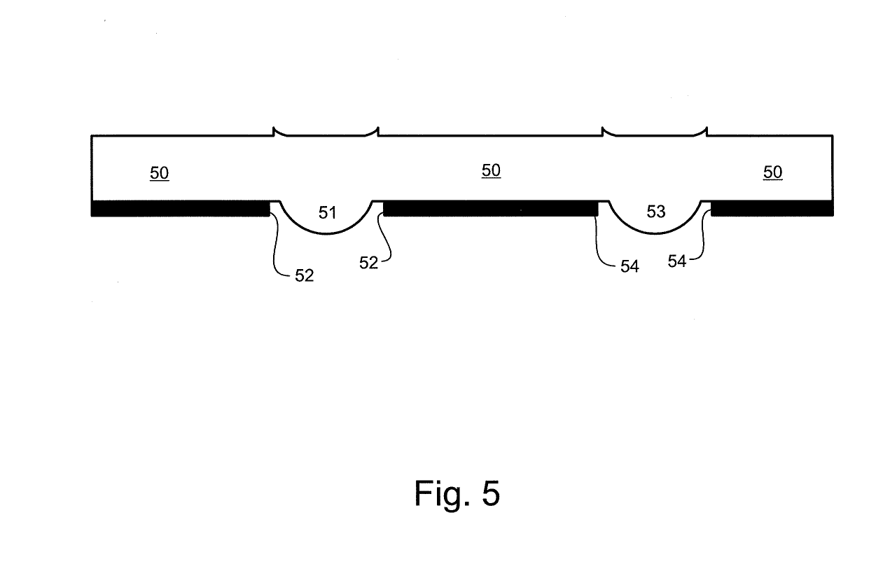

FIG. 5 illustrates a wafer level assembly comprising an optical wafer and a plurality of apertures according to one embodiment of the present invention. As illustrated in FIG. 5, the optical wafer (50) comprises a first optical element (51) and a first aperture (52) aligned with the first optical element (51), the first aperture (52) comprising electroless nickel. The optical wafer (50) further comprises a second optical element (53) and a second aperture (54) aligned with the second optical element (53), the second aperture (54) comprising electroless nickel. In some embodiments, the first aperture (52) and the second aperture (54) are continuous with one another.

In some embodiments, a spacer wafer comprising a first perforation is coupled to the optical wafer, wherein the first perforation is aligned with the first aperture of the optical wafer. In some embodiments, the spacer wafer further comprises a second perforation aligned with the second aperture of the optical wafer. In some embodiments, the spacer wafer is used to couple the optical wafer to an electro-optical element wafer. In some embodiments, an electro-optical element wafer comprises a first electro-optical element aligned with the first aperture. In some embodiments, the electro-optical element wafer comprises a second electro-optical element aligned with the second aperture. The first and second electro-optical elements, in some embodiments, can comprise any electro-optical element construction described herein.

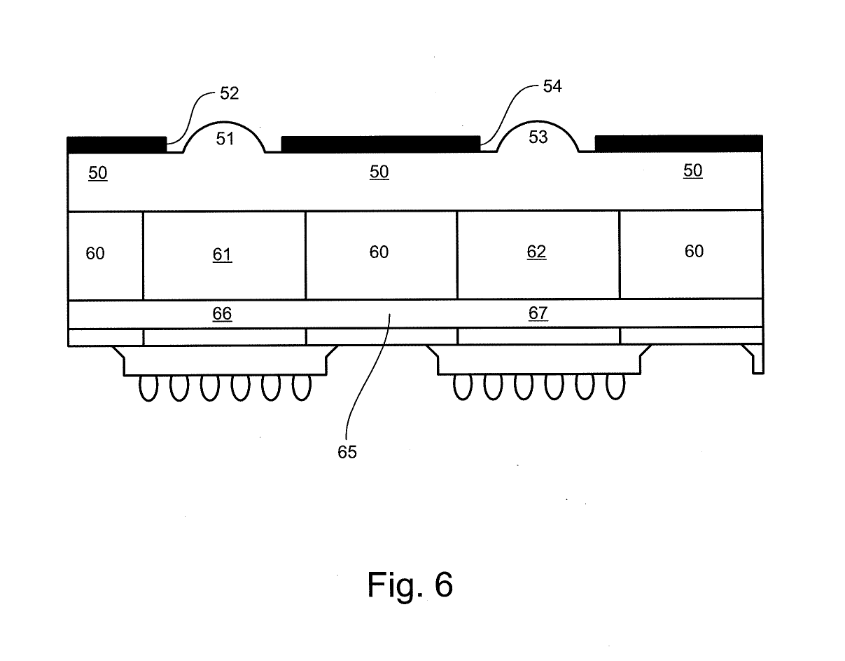

FIG. 6 illustrates the wafer level optical assembly of FIG. 5 further comprising a spacer wafer and an electro-optical element wafer according to one embodiment of the present invention. As illustrated in FIG. 6, a spacer wafer (60) is coupled to the optical wafer (50). The spacer wafer comprises a first perforation (61) aligned with the first aperture (52) and a second perforation (62) aligned with the second aperture (54). An electro-optical element wafer (65) is coupled to the spacer wafer (60). The electro-optical element wafer (65) comprises a first electro-optical element (66) aligned with the first aperture (52) and a second electro-optical element (67) aligned with the second aperture (54).

In another aspect, the present invention provides methods of providing optical apertures. In some embodiments, a method of providing at least one optical aperture comprises providing a substrate comprising a coating, selectively removing portions of the coating from the substrate, depositing an aperture material on substrate surfaces where the coating has been removed or substantially removed, coupling a wafer to the deposited aperture material and removing the aperture material from the substrate to provide the at least one optical aperture.

In some embodiments, a method of providing at least one optical aperture comprises providing a substrate, patterning an aperture material on the substrate, coupling a wafer to the patterned aperture material, and removing the aperture material from the substrate to provide the at least one optical aperture. In some embodiments, patterning an aperture material on the substrate comprises depositing the aperture material on the substrate and selectively removing portions of the aperture material to provide a pattern of the aperture material. In some embodiments wherein an aperture material is patterned on the substrate, the substrate does not comprise a coating as described herein.

A substrate for use in the various embodiments of methods described herein can comprise any substrate not inconsistent with the objects of the present invention. In some embodiments, a substrate comprises a material operable to form a removable oxide coating. In some embodiments, for example, a substrate comprises silicon, aluminum or titanium. A substrate, in some embodiments, comprises a material operable to be patterned with a resist material. In some embodiments, a substrate comprises a metal including, but not limited to, nickel, copper, zinc, silver or gold or alloys thereof. In some embodiments, a substrate comprises glass.

Moreover, in some embodiments, a substrate comprises one or more polymeric materials. A polymeric material, in some embodiments, comprises one or more polyolefins, polyamides, polyurethanes, polyesters, polycarbonates or fluoropolymers. In some embodiments, a polyolefin comprises polyethylene, polypropylene, polybutene or mixtures or copolymers thereof. In some embodiments, a fluoropolymer comprises polytetrafluoroethylene (PTFE), polyvinylfluoride (PVF), polyvinylidene fluoride (PVDF) or mixtures or copolymers thereof.

A substrate for use in the various embodiments of methods described herein can have any dimensions not inconsistent with the objectives of the present invention. In some embodiments, a substrate has a thickness of at least about 250 μm. In some embodiments, a substrate has a thickness ranging from about 500 μm to about 10 mm. A substrate, in some embodiments, has a thickness ranging from about 1 mm to about 5 mm. In some embodiments, a substrate has a thickness ranging from about 2 mm to about 4 m.

As described herein, a substrate, in some embodiments, comprises a coating. A coating, in some embodiments, can comprise any material that precludes or substantially precludes the deposition of an aperture material on the substrate. In some embodiments, a substrate coating is selected according to the identity of the aperture material to be deposited. In some embodiments, a coating comprises an oxide. In some embodiments, for example, an oxide coating comprises a silicon oxide, aluminum oxide or a titanium oxide. In some embodiments, a coating comprises a lithographic resist material. In some embodiments, a lithographic resist comprises a positive resist material, a negative resist material or combinations thereof. In some embodiments, a lithographic resist comprises one or more acidic functionalities. In some embodiments, a lithographic resist comprises Shin-Etsu SIPR® 7120M-20, MacDermid Santek or Micro Chem KMPR 1000.

Moreover, an aperture material can comprise any material not inconsistent with the objectives of the present invention. In some embodiments, an aperture material comprises a metal or alloy. In some embodiments, a metal comprises aluminum, nickel, copper, zinc, silver or gold or alloys thereof. In some embodiments, for example, an aperture comprises electrolessly deposited nickel as described herein. In some embodiments, an aperture material comprises one or more polymeric materials. A polymeric material, in some embodiments, comprises a lithographic resist material. In some embodiments, an aperture material comprises a lithographic resist material, including any lithographic resist material described herein.

In some embodiments of methods described herein, a substrate and an aperture material for deposition on the substrate are selected according to a ratio of their respective coefficients of thermal expansion (CTE). A CTE ratio of the aperture material and substrate, as used herein, is defined in Equation (I):

CTE Ratio=(Aperture material CTE)/(Substrate CTE) (I)

In some embodiments, the aperture material and the substrate have a CTE ratio of greater than 1. In some embodiments, the aperture material and the substrate have a CTE ratio of at least about 5 or at least about 7. The aperture material and the substrate, in some embodiments, have a CTE ratio of at least about 10 or at least about 15. In some embodiments, the aperture material and the substrate have a CTE ratio ranging from about 2 to about 20 or from about 3 to about 10. As described further herein, the aperture material and substrate, in some embodiments, have a minimum CTE ratio to permit release of the aperture material from the substrate when the substrate is heated.

In some embodiments of methods described herein, a substrate and an aperture material are selected according to the adhesion characteristics of the aperture material to the substrate. In some embodiments, an aperture material has a poor adhesion to the substrate such that the aperture material can be removed upon heating the substrate and/or mechanically perturbing the substrate. Mechanical perturbation of the substrate, in some embodiments, comprises bending, flexing and/or compressing the substrate.

In embodiments of methods described herein, a wafer is coupled to the deposited aperture material. In some embodiments, a wafer coupled to the aperture material comprises a perforation aligned with the at least one aperture. In some embodiments wherein a plurality of apertures are produced, the wafer coupled to the deposited aperture material comprises a plurality of perforations aligned with the plurality of apertures. In some embodiments, a wafer coupled to the aperture material is non-radiation transmissive as described herein. In some embodiments, a wafer coupled to the deposited aperture material is a spacer wafer.

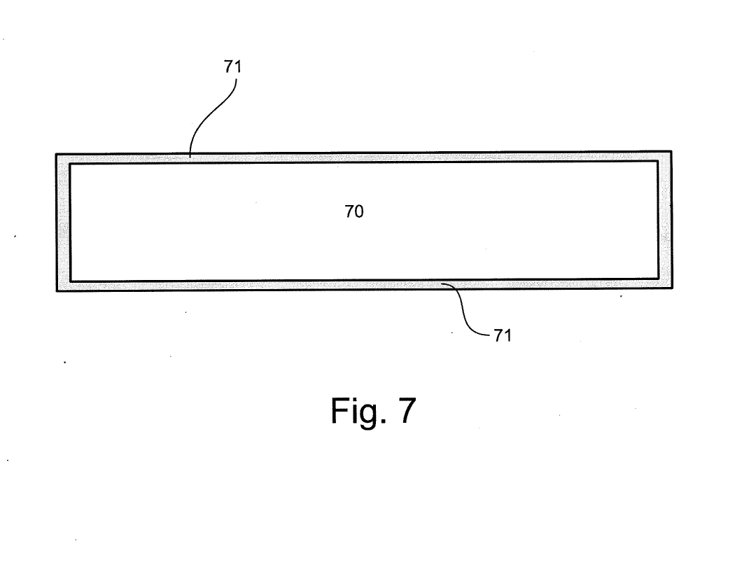

FIG. 7 illustrates an oxide coated substrate according to one embodiment of a method described herein. The substrate (70) in the embodiment of FIG. 7 comprises silicon having a oxide coating (71). In some embodiments, an oxide coating can be formed on a silicon substrate by heating the silicon substrate in a furnace in the presence of air or oxygen.

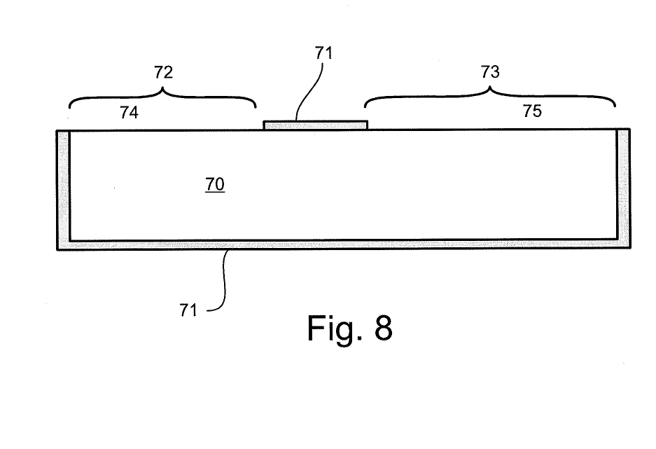

FIG. 8 illustrates the oxide coated substrate of FIG. 7, wherein the oxide coating has been selectively removed according to one embodiment of a method described herein. As illustrated in FIG. 8, the oxide coating (71) has been removed from portions (72, 73) of the silicon substrate (70), thereby exposing silicon surfaces (74, 75) in preparation for deposition of an aperture material on the exposed surfaces (74, 75).

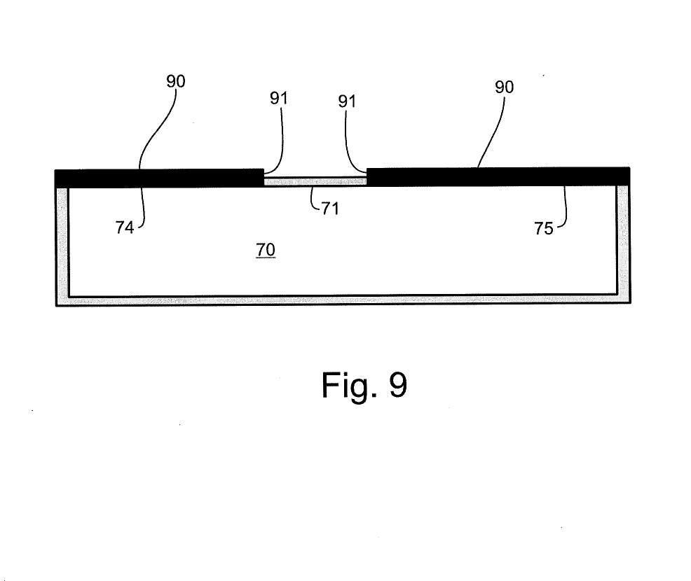

FIG. 9 illustrates depositing an aperture material on the substrate of FIG. 8 having selected portions of the oxide coating removed according to one embodiment of a method described herein. In the embodiment of FIG. 9, a nickel aperture material (90) is electrolessly deposited on the exposed surfaces (74, 75) of the silicon substrate (70). The nickel aperture material (90) is not deposited on regions of the silicon substrate (70) where the oxide coating (71) remains. The oxide coating (71), for example, can preclude the nickel aperture material (90) from plating out of solution. The inability to deposit the nickel aperture material (90) on regions of the silicon substrate (70) where the oxide coating (71) remains assists in forming the aperture (91).

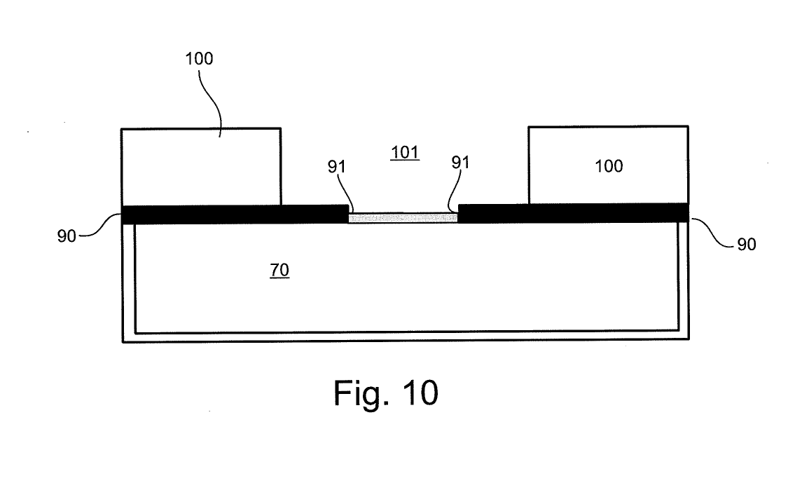

FIG. 10 illustrates coupling a spacer wafer to the deposited aperture material of FIG. 9 according to one embodiment of a method described herein. As illustrated in FIG. 10, a spacer wafer (100) is coupled to the electrolessly deposited nickel aperture material (90). The spacer wafer (100) comprises a perforation (101) aligned with the aperture (91). In some embodiments, the spacer wafer (100) is coupled to the aperture material (91) by an adhesive or other bonding species.

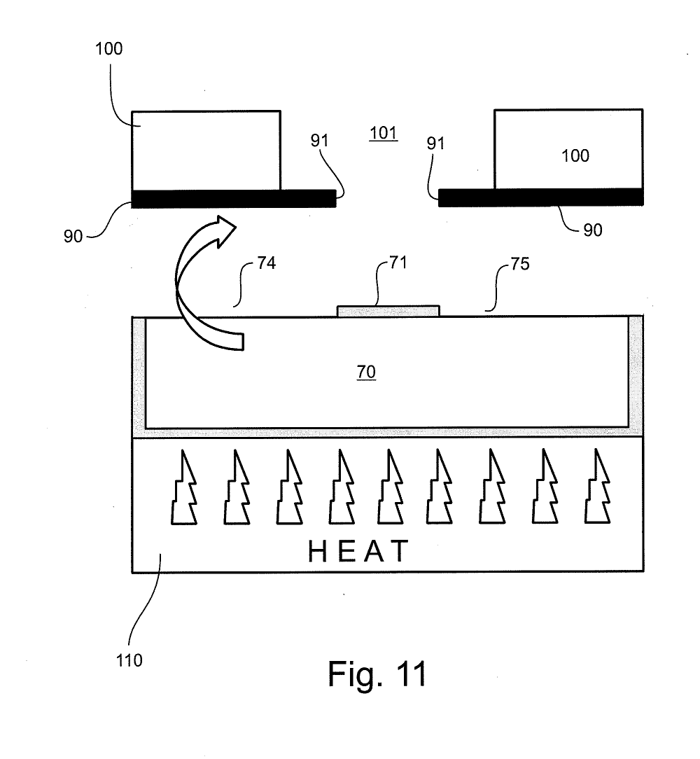

FIG. 11 illustrates removal of the electroless nickel aperture of FIG. 10 from the silicon substrate according to one embodiment of a method described herein. In the embodiment of FIG. 11, the silicon substrate (70) is heated (110) thereby releasing the electrolessly deposited nickel aperture (91) from the silicon substrate (70). As the silicon substrate (70) and the electroless nickel aperture material (90) have a CTE ratio of about 9, heating the silicon substrate (70) releases the nickel aperture (91) and associated spacer wafer (100) from substrate surfaces (74, 75) to provide a wafer level assembly described herein. Moreover, the substrate (70) can be reused for production of another wafer level assembly comprising an optical aperture.

In some embodiments, a wafer coupled to the deposited aperture material, according to methods described herein, is an optical wafer. In some embodiments, an optical wafer coupled to the deposited aperture material comprises an optical element aligned with the at least one aperture. In some embodiments wherein a plurality of optical apertures are produced, the optical wafer coupled to the deposited aperture material comprises a plurality of optical elements aligned with the plurality of apertures. In some embodiments wherein an optical wafer is coupled to the deposited aperture material, the substrate comprises one or more recesses operable to accommodate optical elements aligned with the formed apertures.

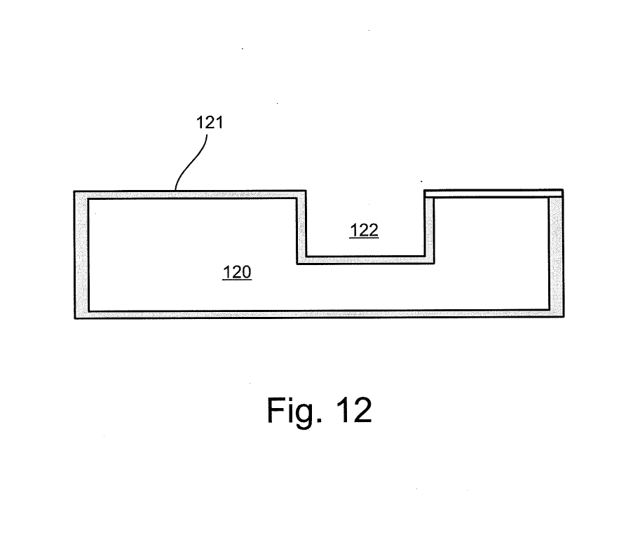

FIG. 12 illustrates an oxide coated substrate comprising a recess operable to accommodate an optical element of an optical wafer according to one embodiment of a method described herein. In the embodiment of FIG. 12, the substrate (120) comprises silicon having an oxide coating (121). A recess (122) has been etched into the silicon substrate (120) prior to deposition of the oxide coating (121), wherein the recess (122) has dimensions suitable for receiving an optical element of an optical wafer.

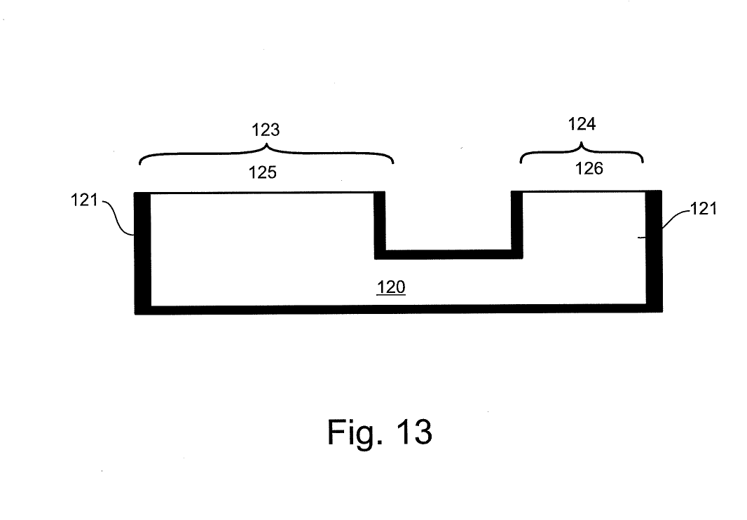

FIG. 13 illustrates the oxide coated substrate of FIG. 12, wherein the oxide coating has been selectively removed according to one embodiment of a method described herein. As illustrated in FIG. 13, the oxide coating (121) has been selectively removed from portions (123, 124) of the silicon substrate (120), thereby exposing silicon surfaces (125, 126) in preparation for deposition of an aperture material on the exposed surfaces (125, 126).

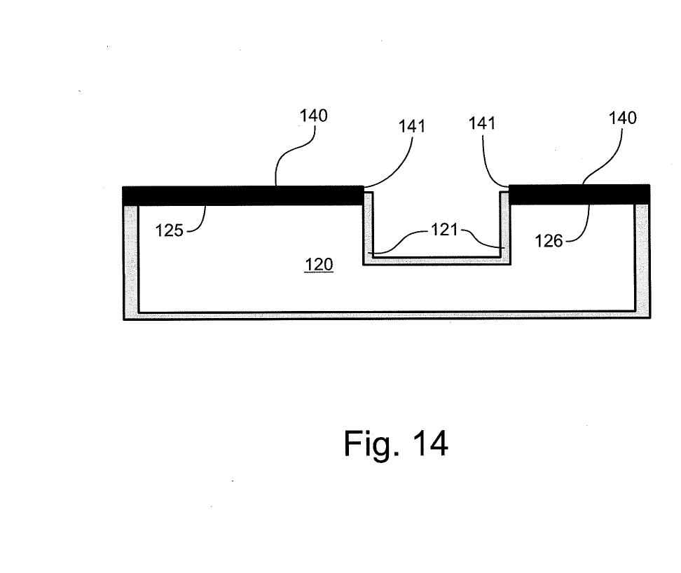

FIG. 14 illustrates depositing an aperture material on the substrate of FIG. 13 having portions of the oxide coating removed according to one embodiment of a method described herein. In the embodiment of FIG. 14, a nickel aperture material (140) is electrolessly deposited on the exposed surfaces (125, 126) of the silicon substrate (120). As provided herein, the nickel aperture material (140) is not deposited on regions of the silicon substrate (120) where the oxide coating (121) remains. The inability to deposit the nickel aperture material (140) on regions of the silicon substrate (120) where the oxide coating (121) remains assists in forming the aperture (141).

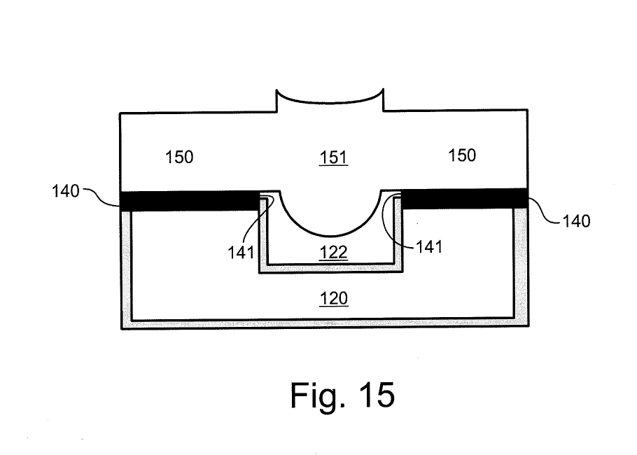

FIG. 15 illustrates coupling an optical wafer comprising an optical element to the deposited aperture material of FIG. 14 according to one embodiment of a method described herein. As illustrated in FIG. 15, an optical wafer (150) comprising at least one optical element (151) is coupled to the electrolessly deposited nickel aperture material (140), wherein the optical element (151) is aligned with the aperture (141) and accommodated by the recess (122) etched into the silicon substrate (120). In some embodiments, the optical wafer (150) is coupled to the aperture material (140) by an adhesive or other bonding species.

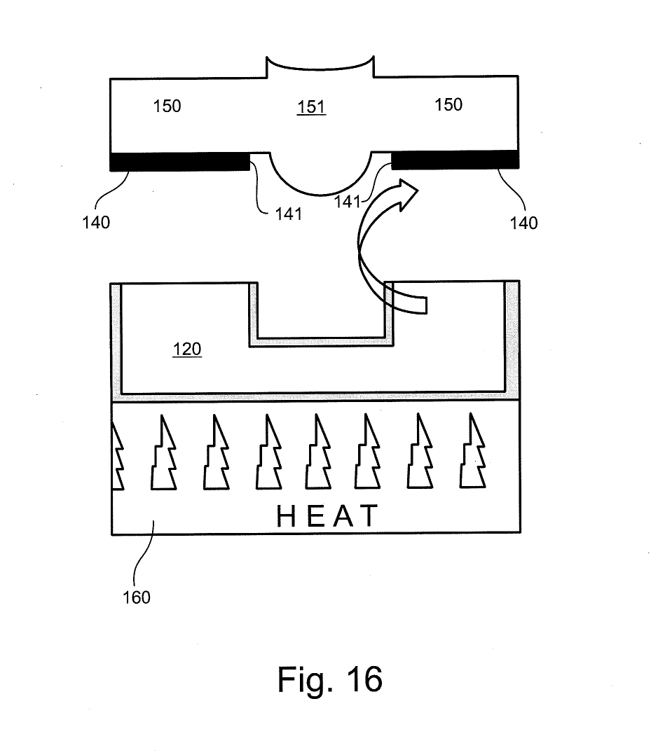

FIG. 16 illustrates removal of the nickel aperture from the silicon substrate according to one embodiment of a method described herein. In the embodiment of FIG. 16, the silicon substrate (120) is heated (160) thereby releasing the electrolessly deposited nickel aperture (141) from the silicon substrate (120). As the silicon substrate (120) and the electroless nickel aperture material (140) have a CTE ratio of about 9, heating the silicon substrate (120) releases the nickel aperture (141) and associated optical wafer (150) from the substrate surfaces (125, 126) to provide a wafer level assembly described herein. Moreover, the substrate (120) can be reused for production of another wafer level assembly comprising an optical aperture.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

That which is claimed is:

1. A wafer level assembly comprising:
a first wafer comprising a first perforation; and
a first aperture aligned with the first perforation and coupled to the first wafer.

2. The wafer level assembly of claim 1, wherein the first wafer is non-radiation transmissive.

3. The wafer level assembly of claim 1, wherein the first wafer comprises a fiber reinforced polymeric material.

4. The wafer level assembly of claim 1 further comprising an optical wafer coupled to the first wafer, the optical wafer comprising a first optical element aligned with the first aperture and spaced apart from the first aperture by the first wafer.

5. The wafer level assembly of claim 4, further comprising a second wafer comprising a first perforation aligned with the first aperture, the second wafer coupled to one of the first wafer and the optical wafer.

6. The wafer level assembly of claim 5, wherein the second wafer is non-radiation transmissive.

7. The wafer level assembly of claim 5 further comprising an electro-optical element wafer coupled to the second wafer such that the first aperture is disposed between and spaced apart from the first optical element and the electro-optical element wafer.

8. The wafer level assembly of claim 5 further comprising an electro-optical element wafer coupled to the second wafer such that the first optical element is disposed between and spaced apart from the first aperture and the electro-optical element wafer.

9. The wafer level assembly of claim 1 further comprising a second wafer comprising a second perforation aligned with the first aperture, the second wafer coupled to the first wafer with the first aperture disposed between the first and second wafers.

10. The wafer level assembly of claim 1, wherein the first aperture comprises electroless nickel.

11. The wafer level assembly of claim 1, wherein the first aperture comprises a lithographic resist material.

12. The wafer level assembly of claim 1, wherein the first aperture comprises a polymeric material.

13. A wafer level optical assembly comprising:
an optical wafer comprising a first optical element; and
a first aperture aligned with the first optical element and coupled to a surface of the optical wafer, the first aperture comprising electroless nickel.

14. The wafer level assembly of claim 13 further comprising a spacer wafer comprising a first perforation coupled to the optical wafer, the first perforation aligned with the first optical element.

15. The wafer level assembly of claim 14 further comprising an electro-optical element wafer coupled to the spacer wafer, the electro-optical element wafer comprising a first electro-optical element aligned with the first optical element.

16. The wafer level assembly of claim 13, wherein the optical wafer further comprises a second optical element and a second aperture aligned with the second optical element and coupled to a surface of the optical wafer, the second aperture comprising electroless nickel.

17. A method of providing at least one optical aperture comprising:
providing a substrate comprising a coating;
selectively removing portions of the coating from the substrate;
depositing an aperture material on substrate surfaces where the coating has been removed or substantially removed;
coupling a wafer to the deposited aperture material; and
removing the aperture material from the substrate to provide the at least one optical aperture.

18. The method of claim 17, wherein the coating comprises an oxide.

19. The method of claim 17, wherein the coating comprises a lithographic resist.

20. The method of claim 17, wherein the coating comprises a polymeric material.

21. The method of claim 18, wherein the substrate comprises silicon, aluminum or titanium.

22. The method of claim 17, wherein the aperture material comprises a metal.

23. The method of claim 22, wherein the metal comprises electroless nickel.

24. The method of claim 17, wherein the aperture material comprises a lithographic resist.

25. The method of claim 17, wherein the aperture material comprises a polymeric material.

26. The method of claim 17, wherein the substrate and the aperture material have a coefficient of thermal expansion ratio (CTE) greater than 1.

27. The method of claim 17, wherein the substrate and the aperture material have a CTE ratio of at least about 5.

28. The method of claim 17, wherein the substrate and the aperture material have a CTE ratio of at least about 10.

29. The method of claim 17, wherein the wafer coupled to the aperture material comprises a perforation aligned with the at least one aperture.

30. The method of claim 17, wherein the wafer comprises a spacer wafer.

31. The method of claim 17. wherein the wafer coupled to the aperture material comprises an optical wafer.

32. The method of claim 31, wherein the optical wafer comprises an optical element aligned with the at least one aperture.

33. The method of claim 32, wherein the substrate comprises a recess operable to accommodate the optical element.

34. The method of claim 17, wherein removing the aperture material comprises heating the substrate to release the aperture material coupled to wafer.

35. A method of providing at least one optical aperture comprising:
providing a substrate;
patterning an aperture material on the substrate;
coupling a wafer to the patterned aperture material; and
removing the aperture material from the substrate to provide the at least one optical aperture.

36. The method of claim 35 wherein patterning an aperture material comprises depositing the aperture material on the substrate and selectively removing portions of the aperture material.

37. The method of claim 36, wherein the substrate does not comprise a coating.

38. The method of claim 35, wherein the aperture material comprises a polymeric material.

39. The method of claim 35, wherein the aperture material comprises a lithographic resist.

40. The method of claim 35, wherein the substrate and the aperture material have a CTE ratio greater than 1.

41. The method of claim 35, wherein the substrate and the aperture material have a CTE ratio of at least about 5.

42. The method of claim 35, wherein the substrate and the aperture material have a CTE ratio of at least about 10.

43. The method of claim 35, wherein removing the aperture material comprises heating the substrate to release the aperture material coupled to wafer.
